(19) United States
(12) Patent Application Publication
(10) Pub. No.: US 2025/0224242 A1
(43) Pub. Date: Jul. 10, 2025

(54) NAVIGATION GUIDANCE FOR VEHICLES TO REDUCE CARBON EMISSION EXPOSURE

(71) Applicant: Honda Motor Co., Ltd., Tokyo (JP)

(72) Inventor: Robert M. Uyeki, Torrance, CA (US)

(21) Appl. No.: 18/406,770

(22) Filed: Jan. 8, 2024

(51) Int. Cl. G01C 21/34; G06Q 30/0207; G06Q 30/0234; G07C 5/08

(52) U.S. Cl. CPC G01C 21/3469; G06Q 30/0215; G06Q 30/0234; G07C 5/085

(57) ABSTRACT

Systems and methods for managing the carbon emissions of vehicles. A server may receive information about a vehicle's current location and fuel status along with other telemetry data. The server can identify fueling stations appropriate for the vehicle's engine type within driving range of the vehicle. The server can further calculate an estimated carbon content of the fuel offered by each of the nearby fueling stations and determine which station would provide fuel with the lowest overall carbon content. Based on this decision, the server can cause the vehicle's navigation system to present a map that routes the vehicle to the fueling station that would minimize carbon emissions. The server can also maintain an accounting of the vehicle's carbon emissions, and may also facilitate reimbursements to drivers when the fuel is more costly than more carbon intense fuel.

### BACKGROUND

The present disclosure generally relates to reducing carbon emissions exposure for vehicles and, more particularly, to a system and method for identifying fueling stations serving fuel with lower carbon intensity and re-routing consumers to these locations.

As the effects of climate change are becoming more pronounced in recent years, governments, corporations, and individuals alike are becoming more concerned with the contributions of their own activities to climate change. Many are engaging in discussions on managing climate change and measuring their “carbon footprint” or greenhouse gas (GHG) emissions resulting from products or activities, to identify strategies to reduce their climate impacts. For guidance in how to prepare their footprint inventories, these groups look to existing carbon footprint protocols. These existing protocols vary in scope, but generally require reporting of emissions from sources under the company's direct control (“Scope 1”) and emissions from direct purchased energy (“Scope 2”), with less focus on indirect emissions upstream and downstream in the company's value chain (optional “Scope 3”). For most business sectors with the exception of a few sectors with large and well-known GHG emissions like power generation, transportation suppliers, and cement manufacturing, carbon footprints from direct emissions and purchased energy use have been shown to be a small portion of the total carbon footprint. Estimates have indicated that on average, Scope 1 emissions from an industry are only 14% of the total upstream supply chain carbon emissions, and the sum of emissions from Scopes 1 and 2, on average, only 26% of total upstream supply chain emissions, leaving a significant portion of the supply chain emissions in the nonmandatory “Scope 3” category, which combines all non-Scope 1 and 2 sources of emissions.

Currently companies can choose to voluntarily disclose Scope 3 emissions, but they do not have much guidance or framework for doing so, and the resulting Scope 3 disclosures are not necessarily consistent or comparable between companies even in the same sector. Although Scope 3 emissions are widely known to be important, they are rarely estimated because they are not well understood, and there is little motivation or technical capacity to do so in current carbon footprint protocols. Better informing and estimating the process of Scope 3 supply chain footprint information can help firms pursue emissions mitigation projects both within their own plants and also across their supply chain. As companies can often influence their suppliers, a broader estimation can similarly motivate more effective corporate climate change policies.

Therefore, there is a need for a system that may facilitate coordination between companies and consumers to effectively track and manage GHG emissions and address the shortcomings described above.

### SUMMARY

The disclosed embodiments provide methods and systems for automatic monitoring, management, and navigation of vehicles to fueling stations offering cleaner fuel.

In one aspect, a method of routing vehicles to fueling sources with lower carbon content is disclosed. The method may include receiving, at a server, first telemetry data from a vehicle including a current location of the vehicle, and an indication that a current fuel level of the vehicle has fallen below a first threshold. The method also includes identifying, within a first driving range of the vehicle from its current location, a group of fueling stations including a first fueling station and a second fueling station, and calculating, based on a first location of the first fueling station, a first carbon content associated with fuel provided by the first fueling station. The method can further include calculating, based on a second location of the second fueling station, a second carbon content associated with fuel provided by the second fueling station that is higher than the first carbon content. In addition, the method includes generating, in response to the second carbon content being higher than the first carbon content, a first route from the current location to the first fueling station, and transmitting to the vehicle, for presentation by a navigation system for the vehicle, the first route.

In another aspect, another method of routing vehicles to fueling sources with lower carbon content is disclosed. The method may include: receiving, at a server, first telemetry data from a vehicle including a current location of the vehicle, a target destination, and an indication that a current fuel level of the vehicle has fallen below a fuel threshold; identifying, within a first driving range of the vehicle as it travels from its current location to the target destination, a group of fueling stations including a first fueling station and a second fueling station; calculating, based on a first location of the first fueling station, a first carbon content associated with fuel provided by the first fueling station; calculating, based on a second location of the second fueling station, a second carbon content associated with fuel provided by the second fueling station that is higher than the first carbon content; generating, in response to the first carbon content being less than the preselected carbon content threshold, a first route from the current location to the target destination that includes a detour to the first fueling station; and transmitting to the vehicle, for presentation by a navigation system for the vehicle, the first route.

In another aspect, a system for routing vehicles to fueling sources with lower carbon content includes a processor and machine-readable media including instructions which, when executed by the processor, cause the processor to: (1) receive, at a server, first telemetry data from a vehicle including a current location of the vehicle, and an indication that a current fuel level of the vehicle has fallen below a first threshold; (2) identify, within a first driving range of the vehicle from its current location, a group of fueling stations including a first fueling station and a second fueling station; (3) calculate, based on a first location of the first fueling station, a first carbon content associated with fuel provided by the first fueling station; (4) calculate, based on a second location of the second fueling station, a second carbon content associated with fuel provided by the second fueling station that is higher than the first carbon content; (5) generate, in response to the second carbon content being higher than the first carbon content, a first route from the current location to the first fueling station; and (6) transmit to the vehicle, for presentation by a navigation system for the vehicle, the first route.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments may be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIGS. 1A and 1B depict an example in which a vehicle navigation system presents routing options for fueling stations offering fuel with different carbon contents, in accordance with an embodiment of the disclosure;

FIG. 2 is a schematic diagram illustrating the selection of one route that directs the vehicle to a clean fueling station, in accordance with an embodiment of the disclosure;

FIG. 3 is an example of a user interface for a cleaner energy application that includes options to view a vehicle's carbon emissions and reimbursements, in accordance with an embodiment of the disclosure;

FIG. 4 is a schematic diagram showing an environment in which a clean energy navigation system can be implemented, in accordance with an embodiment of the disclosure; and

FIG. 5 is a flow chart of a process of routing vehicles to fueling sources with lower carbon content, in accordance with an embodiment of the disclosure.

### DETAILED DESCRIPTION

Carbon management policies to address climate change and global warming are increasingly recognized as a business reality. However, in this context of a carbon-constrained business future, there remains uncertainty over how a shift to a low-carbon business market will manifest. Furthermore, companies across different industry sectors are beginning to appreciate the carbon issue as one of the critical factors in supply chain management rather than the more simplistic firm-to-firm approach. For example, car manufacturers rely heavily on suppliers of steel, glass, rubber, and plastics, all of whom are likely to be seriously affected by emission requirements and regulations. However, focus has remained mainly on producer and/or manufacturer-related aspects, while supplier aspects are rarely explored.

The term carbon footprint has come into wide use among academics and practitioners in the last few years. For purposes of this application, carbon footprint can be described as a measure of the total amount of CO₂ emissions that is directly and indirectly caused by an activity or is accumulated over the life stages of a product. Thus, carbon footprint encompasses all direct (on-site, internal) and indirect (off-site, external, upstream, downstream) emissions for measuring carbon footprint in business operations. While some companies are increasingly adopting a life cycle perspective of their carbon impacts in their products and services, manufacturers still struggle to identify and consider their indirect carbon emissions. In other words, rather than focusing primarily on what takes place within the factory, a life cycle perspective traces impacts through the entire production and supply chain of a business. By shifting reporting direct impacts from on-site processes to reporting indirect impacts embodied in the supply chain of a company (upstream) or caused by the use and disposal of its products (downstream), a more comprehensive and accurate assessment of their carbon footprint can be determined.

This is especially true for the transportation sector, which is the largest source of CO₂ emissions in the United States, with gasoline and diesel responsible for 77% of those emissions. Addressing this issue, some original equipment manufacturers (OEMs) try to estimate the emissions for an average life span of their vehicles (e.g., 10 years, 15 years, etc.) based on very generalized data, and in some cases even best-guess calculations, in order to account for each vehicle's end-customer product usage and manage the direct use-phase emissions of their sold products. However, due to the lack of verifiable data, these estimates can lead to significant underestimates and overestimates. For example, vehicle owners may not drive as many miles as estimated, and/or the actual carbon content of fuel that they use to fill their car may be cleaner than average. In other words, OEMs may be overspending or underspending with respect to the energy credits (e.g., RECs) they purchase to compensate for the emissions associated with their vehicle.

As a general matter, a renewable energy certificate, also known as a renewable energy credit (REC) is a tradeable, market-based instrument that represents the legal property rights to the “renewable-ness”—or all non-power attributes—of renewable electricity generation. A REC may be sold separately from the actual electricity (kilowatt-hour, or kWh). The REC owner has exclusive rights to make claims about “using” or “being powered with” the renewable electricity associated with that REC. A REC may be issued for every megawatt-hour (MWh) of electricity generated and delivered to the electric grid from a renewable energy resource. If a person owns RECs associated with a renewable energy source electricity output, these RECs may be sold to another party. In doing so, the owner forfeits the ability to make any claims about their use of that renewable energy, but instead generates a new revenue stream. The revenue is typically a function of the system's kWh output and the market price of RECs. For those who purchase RECs, such as OEMs, there is value in having certified proof that they are using renewable energy from the grid, without having to actually install solar panels or other renewable energy systems at their home or business. This flexibility may allow participants to reduce their carbon footprint. Purchasing RECs also supports the renewable energy market by providing a demand signal to the market, which in turns encourages more supply of renewable energy. In this way, RECs not only help businesses meet their greenhouse gas emission goals-they also encourage the generation of more renewable energy. In some cases, companies can alternatively or additionally opt for a PPA (purchase power agreement) for renewable electricity, which is a contract for the purchase of power and associated renewable energy certificates (RECs) from a specific renewable energy generator (the seller) to a purchaser of renewable electricity (the buyer).

In order to facilitate the tracking, management, and ultimately reduction of their product's emissions, the proposed embodiments dynamically guide consumers to cleaner energy sources in real-time while providing clear, accurate data about fuel sources to the vehicle's OEM or other selected entity. Rather than simply estimating a vehicle's carbon emissions, the system enables the collection of ‘big data’ that reflects individual vehicle activity and fuel consumption. The proposed embodiments can leverage telematics data for each vehicle via the onboard telematics control unit (TCU), including the vehicle's (a) fuel type (e.g., internal combustion engine (ICE), electric vehicle (EV), plug-in hybrid electric vehicle (PHEV), hydrogen vehicle, etc.), (b) mileage, (c) fill amount (e.g., gallons of gas (gal), kilowatt-hour (kWh), pounds (lbs.) hydrogen, etc.), and (d) GPS and time/date data to determine the fuel carbon content. These data can then be used by the system to calculate the carbon content of the fuel that has been supplied to the vehicle, as well as the carbon content of fuel within driving range of the vehicle that could potentially be supplied to the vehicle. In other words, for each type of fuel (e.g., gas) the carbon content of that gas can vary widely based on location—for example, typically fuel obtained in California has significantly less carbon content than the same amount and type of fuel that is obtained in Arizona, as each supply has been generated or collected differently, so that Californian fuel may have a higher proportion of carbon content stemming from renewable energy electrons than from coal generated electrons (i.e., green energy vs brown hydrogen).

As will be described in greater detail below, the proposed embodiments allow participants to track in real-time a “running total” of the pounds (or other metric unit) of carbon emissions for each vehicle and use this information to then optimize REC allocation to correctly account for their carbon footprint. Furthermore, in some embodiments, the system can be used to incentivize users (e.g., drivers) to charge during periods where clean energy is available and/or locations where carbon content of the fuel is less. In one example, the system can automatically determine the incentive amount or value based on the REC payment ‘saved’ by the user choosing the cleaner source. In some embodiments, drivers may be diverted to fueling locations in less carbon-intensive states or locales/geographic areas, or via utility service providers who are known to use renewable energy sources, etc. As data is collected at a vehicle-by-vehicle granular level with respect to each fueling event, the system can more accurately pinpoint fuel sales allocation strategies based on reduced operating expenses for the company based on their expected REC purchase savings.

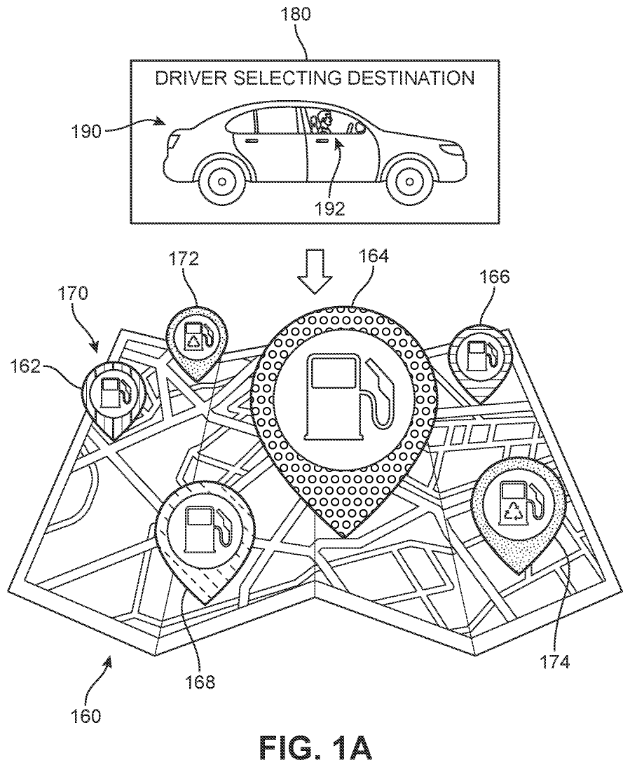

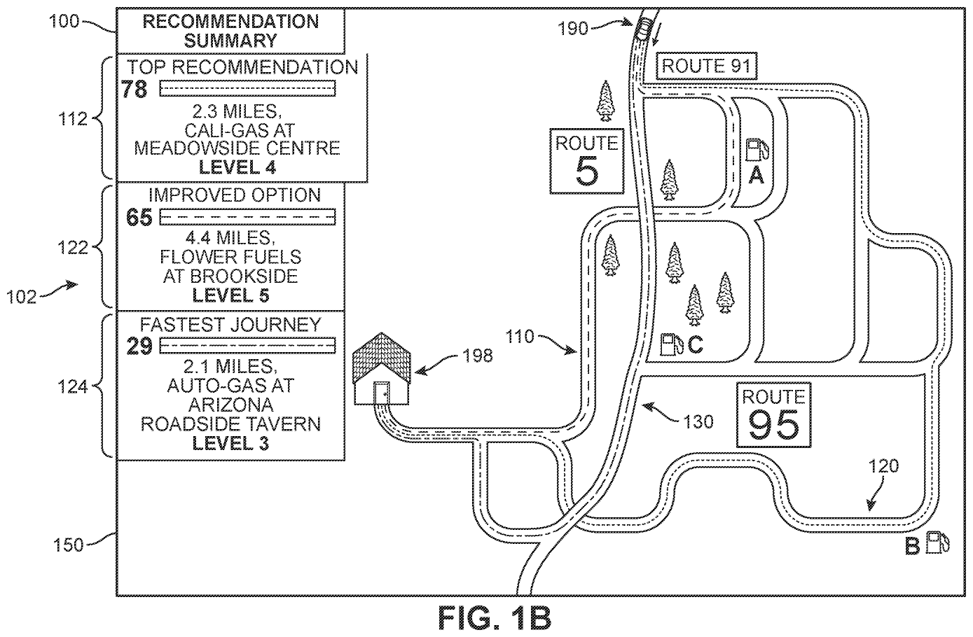

To provide greater context to the reader, FIGS. 1A, 1B, 2, and 3 depict an example scenario in which an embodiment of the proposed systems and methods can be implemented. In FIG. 1A, a vehicle 190 is shown with a driver 192 in the process of selecting a gas station for refueling 180. For example, one embodiment of the proposed systems includes a navigation/mapping application (“navigation app”) accessed via a computing device such as a mobile phone or the vehicle's onboard computing device. In some embodiments, the navigation app can generate an interactive map by which driver 192 can plan their route and identify nearby places of interest such as fueling stations. For purposes of this application, a fueling station refers to any physical site where some type of fuel that may be used by a vehicle is supplied, including but not limited to electric charging, gasoline pumps, hydrogen, etc. Simply for purposes of this example, the vehicle 190 has an internal combustion engine and so the driver 192 is searching for fueling stations that would provide gasoline (e.g., they could initiate a search via the navigation app for “gas stations near me”). However, in other examples, any other vehicle engine type with other fueling systems may benefit from the proposed embodiments. Thus, for purposes of this application, the term “fuel” should be understood to broadly encompass any type of fuel that may be used to power a vehicle, including but not limited to: gasoline, electricity, biodiesel, including vegetable oils, animal fats, or recycled restaurant grease, etc., ethanol, including fuel made from corn and other plant materials, atomic reactor-based fuels, petroleum, hydrogen, natural gas, propane, renewable diesel, sustainable feedstock-based fuel, biobutanol, dimethyl ether, methanol, renewable gasolines, etc. In other words, the proposed systems and methods should be understood to support navigation, reimbursements, incentivization, and other disclosed benefits across vehicles powered by any of these and other fuel types. Any reference to one type of fuel (e.g., gasoline, etc.) in examples described herein are thereby to be understood to be interchangeable with any other fuel type (e.g., electricity, etc.), and should not be understood to limit the applications of the embodiments.

As shown in FIG. 1A, in response to the request, the navigation app can generate and present an interactive map 160 that calls out or otherwise visually indicates where different gas stations 170 are located in their local area. In some embodiments, the navigation app can incorporate features that provide access crowd-sourced data or other databases offering details about each of the gas stations 170 to determine (a) the carbon content associated with each of these sources and (b) the cost of the fuel. This is reflected in FIG. 1A by a plurality of icons of varying stippling patterns. In this example, the map 160 shows a first fueling station 162, a second fueling station 164, a third fueling station 166, a fourth fueling station 168, a fifth fueling station 172, and a sixth fueling station 174.

In different embodiments, the icon or other visual presentation of the stations on the map can be adjusted by the system based on the carbon content. In this case, third fueling station 166 is offering fuel that is deemed to be the least carbon footprint friendly or fuel that has a carbon content greater than a first preselected threshold (e.g., “Level 1”). In addition, first fueling station 162 is also markedly unfriendly with respect to carbon emissions, (e.g., “Level 2”), with a carbon content greater than a second preselected threshold that is lower than the first preselected threshold. Furthermore, second fueling station 164—which is the gas station that is preferred by the driver 192—is offering fuel that is also higher than average, with carbon content greater than a third preselected threshold (e.g., “Level 3”) that is lower than the second preselected threshold. However, fifth fueling station 172 and sixth fueling station 174 each are more carbon friendly, with a carbon content greater than a fourth preselected threshold (e.g., “Level 4”) that is lower than the third preselected threshold. Finally, fourth fueling station 168 is deemed to be the optimal station in range, with a carbon content greater than a fifth preselected threshold (e.g., “Level 5”) that is even lower than the fourth preselected threshold.

Based on this initial set of data, the driver 192 can quickly ascertain which station would offer the most environmentally-friendly source of fuel. However, this decision could also be facilitated by an awareness of the mileage or distance to each gas station from the vehicle's current location, in different embodiments, the system can further calculate, for each gas station in range, the distance the driver 192 must travel (e.g., mileage), approximately how much fuel would be depleted to reach that gas station, and the corresponding increase in fuel that would be required to re-fill their tank, battery, or other fuel system. In other words, fuel stations that are farther from the current location, even if offering fuel with a lower carbon content than a fuel station that is closer may not be the optimal choice because of the additional distance the vehicle must travel and the carbon emissions that are added during that drivetime.

Moving to FIG. 1B, to allow the driver to better manage and appreciate the nuances of each option, in some embodiments, the system can offer an interactive dashboard 150 that can be displayed to the user. The dashboard 150 can include route planning to the different fueling stations that are available and in range of their current fuel levels, and/or are substantially ‘on the way’ (enroute) to the driver's selected final destination 198 (e.g., their home, office, grocery, etc.). In some embodiments, the system can, based on the driver's destination, general preferences, etc., present proposed routes to the driver. In this example, only three routes are shown for clarity, including a first route 110 (mapping the driver to a first station “A”), a second route 120 (mapping the driver to a second station “B”), and a third route 130 (mapping the driver to a third station “C”). In some embodiments, dashboard 150 can also or alternatively present a recommendation summary 100 that encapsulates the pertinent information for each fueling station that has been mapped. As shown in FIG. 1B, a first option 112 is identified as the top “recommended option” based on the system calculating that the combination of the driving distance (to take into account the difference in fuel to be consumed by the vehicle) to first station “A” in the context of their final destination, along with the carbon content (e.g., Level 4) associated with the fuel provided by the station at the current (or proximate) time of day would be most advantageous in terms of overall carbon emissions for the vehicle. A second option 122 is identified as the next “improved option” based on the system calculating that the combination of the driving distance to second station “B” in the context of their final destination, along with the carbon content (e.g., Level 5) associated with the fuel provided by the station at the current (or proximate) time of day would still provide an advantage in terms of overall carbon emissions for the vehicle relative to other stations. In addition, a third option 132 is identified as the “fastest journey” based on the system calculating that the combination of the driving distance to third station “C” in the context of their final destination, along with the carbon content (e.g., Level 3, which is average) associated with the fuel provided by the station at the current (or proximate) time of day would be either disadvantageous in terms of overall carbon emissions for the vehicle or neutral. Thus, if the driver opts to drive slightly further out (e.g., 2.3 miles rather than 2.1 miles) they can make a more environmentally conscious choice with minimal effect on their drive time.

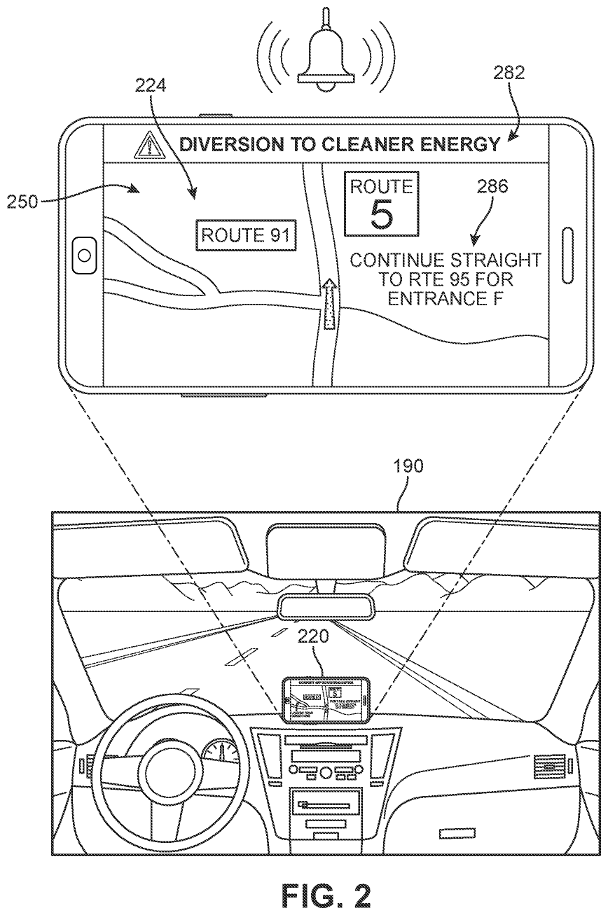

It can be appreciated that other factors may come into play when making these types of decisions. Moving now to FIG. 2, an example of navigation app 224 is depicted on a mobile computing device 220 as it presents a map interface 250 to the selected fueling station. In this example, the driver of vehicle 190 has chosen the recommended option and is offered guidance 286 or step-by-step directions for approaching/navigating to first station “A”. In some embodiments, the system can also generate positive feedback 282 or other encouraging messaging (e.g., “Diversion to Cleaner Energy”) as a form of incentivization based on personal recognition/credit that they are making a choice to re-route to a different station in order to help reduce their carbon footprint.

In different embodiments, the vehicle and/or driver may be associated with a system account by which various historical data, preferences, and transactional events can be recorded. After the vehicle has been re-fueled at the station with lower carbon content fuel, in different embodiments, additional rewards and/or reimbursement may be generated and automatically provided to the driver's account by the system as part of an incentivization program. In different embodiments, the reimbursement amount/value can be calculated by the system based on one or more factors including but not limited to: (a) the increase in cost (if any) between the selected lower-carbon content fuel and the fuel source that was nearest/least out of the way for the driver and would have otherwise been their normal/preferred fuel station, and (b) the increased distance (if any) traveled between the selected lower-carbon content fueling station and the fueling station that was nearest/least out of the way for the driver and would have otherwise been their normal/preferred fuel station.

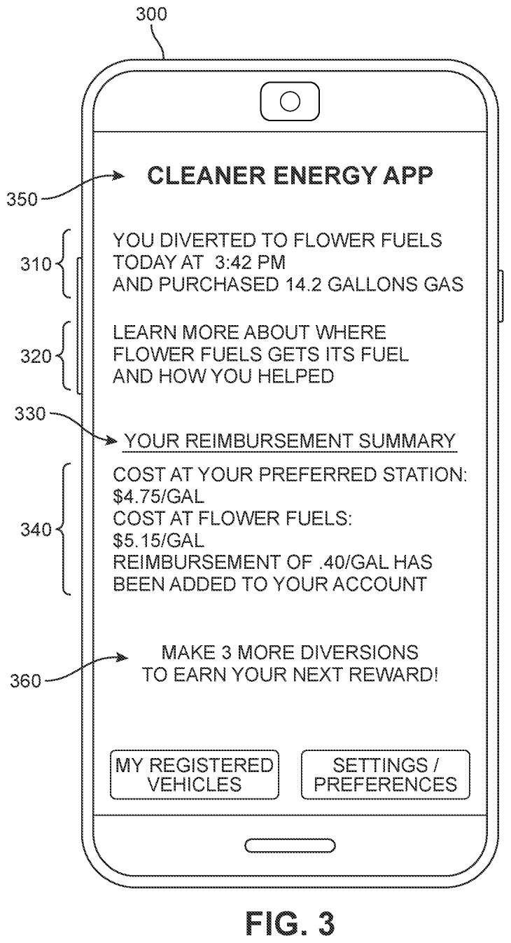

For purposes of illustration, one example of an account interface for managing different features offered by the system is shown in FIG. 3. The driver can access, for example, a cleaner energy app 350 provided by the system via a computing device 300 that allows the driver to view their account activity and other related data maintained by the system. In this example, upon opening the cleaner energy app 350, an overview page is presented describing their most recent fuel transaction 310 (“You diverted to Flower Fuels today at 3:42 pm and purchased 14.2 gallons of gas”). In some embodiments, an optional contextual data option 320 can be provided, which if selected can show the user information that was used to calculate the carbon content of the fuel at the selected fueling station (e.g., “Learn more about where Flower Fuels gets its fuel and how you helped”), information which in itself can serve both to educate the user and further encourage their diversions to cleaner fuel. This data can be harvested from the crowdsourced data and/or database where real-time and near-real time information about the sources of energy where the fuel stations acquire their fuel.

Furthermore, as noted above, in some embodiments, the system can calculate the difference in cost/mileage between the driver's original fuel station and the one to which they re-routed/diverted in order to determine whether any reimbursement is to be made and the amount of such reimbursement. If a difference is calculated, the system can automatically generate a payment and transfer the funds to the user's app account or other preferred banking/financial transaction system or app. In one example, the cleaner energy app 350 can inform the user about any reimbursements and their status, as reflected in a reimbursement summary 330 presented in the account interface. In this case, reimbursement details 340 (“Cost at your preferred station: $4.75/Gal, Cost at Flower Fuels: $5.15/Gal, reimbursement of 0.40/Gal has been added to your account”) indicate that the system has not detected a sufficiently large deviation in mileage between the two stations, and so the reimbursement is based primarily on the difference in cost. If the mileage difference had been greater, the reimbursement may also be updated to reimburse the driver for the cost of fuel that was added to their trip in order to travel to the recommended fueling station.

In addition, in still other embodiments, additional incentives can be offered to the user. For example, in different embodiments, the system can track how many times the driver has agreed to be rerouted to a fueling station offering cleaner fuel in a given time period. The system can then grant the user one or more rewards based on how many times or how often in a period (e.g., a week, month, year, etc.) the user makes the ‘environmentally friendly’ choice and agrees to be rerouted to a different fueling station (e.g., as represented by reward message 360 “Make 3 more diversions to earn your next reward!”). In some embodiments, this reward can be related to how much carbon was not emitted because of their choices. In another example, the system can convert the amount by which carbon was reduced and present the user with some credit, points, or other token that they can exchange for some tangible reward. Thus, the user can be further incentivized to continue selecting the fuel station that leads to a smaller carbon footprint, and the vehicle OEM can benefit by having their own scope 3 carbon emissions reduced, leading to a similar reduction in the number of RECs they are required to purchase.

As a general matter, vehicle(s) used in the embodiments herein may include suitable logic, circuitry, and/or interfaces, which may be configured to receive fuel (e.g., gas, electric charge, hydrogen, etc.) to run different electronic or electrical components/devices of the vehicle. The vehicle may be a non-autonomous, a semiautonomous, or an autonomous vehicle. Examples of the vehicle may include, but are not limited to, an electric vehicle, a hybrid vehicle, internal combustion vehicle, hydrogen powered vehicle, and/or a vehicle that uses a combination of one or more distinct renewable and non-renewable power sources. Thus, the term EV is used inclusively to refer to plug-in electric vehicles that are variously referred to in the literature as plug-in hybrid electric vehicles (PHEVs), extended range electric vehicles (EREVs), all-electric vehicles (AEVs), battery electric vehicles (BEVs), and plug-in electric vehicles (PEVs), and other hybrid vehicles. In different embodiments, the vehicle that uses renewable and non-renewable power sources may include a fossil fuel-based vehicle, an electric propulsion-based vehicle, a hydrogen fuel-based vehicle, a solar-powered vehicle, and/or a vehicle powered by other forms of alternative energy sources. The vehicle may further include the electronic apparatus that may be configured to communicate with a remote server over a communication network.

The electronic apparatus associated with the vehicle may include suitable logic, circuitry, interfaces, and/or code that may be configured to communicate with the server on behalf of the vehicle over the communication network. The electronic apparatus may be an in-vehicle infotainment system that may be integrated with the vehicle. The in-vehicle infotainment system may include suitable logic, circuitry, interfaces and/or code that may be configured to render at least an audio-based data, a video-based data, and/or a user interface to an occupant of the vehicle. The in-vehicle infotainment system may be configured to execute one or more operations associated with the vehicle. Examples of the in-vehicle infotainment system may include, but are not limited, an entertainment system, a navigation system, a vehicle user interface (UI) system, an Internet-enabled communication system, and other entertainment systems. In some embodiments, the electronic apparatus may be the electronic control unit (ECU) of the vehicle or an electronic dashboard of the vehicle. In other embodiments, the electronic apparatus may be a portable device that may be associated with the occupant of the vehicle. Examples of the portable device may include, but are not limited to, a computing device, a smartphone, a cellular phone, a mobile phone, a gaming device, a camera device, a computer work-station, a personal digital assistant (PDA) and/or a consumer electronic (CE) device.

In different embodiments, the communication network may be one of a wired connection or a wireless connection. Examples of the communication network 114 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

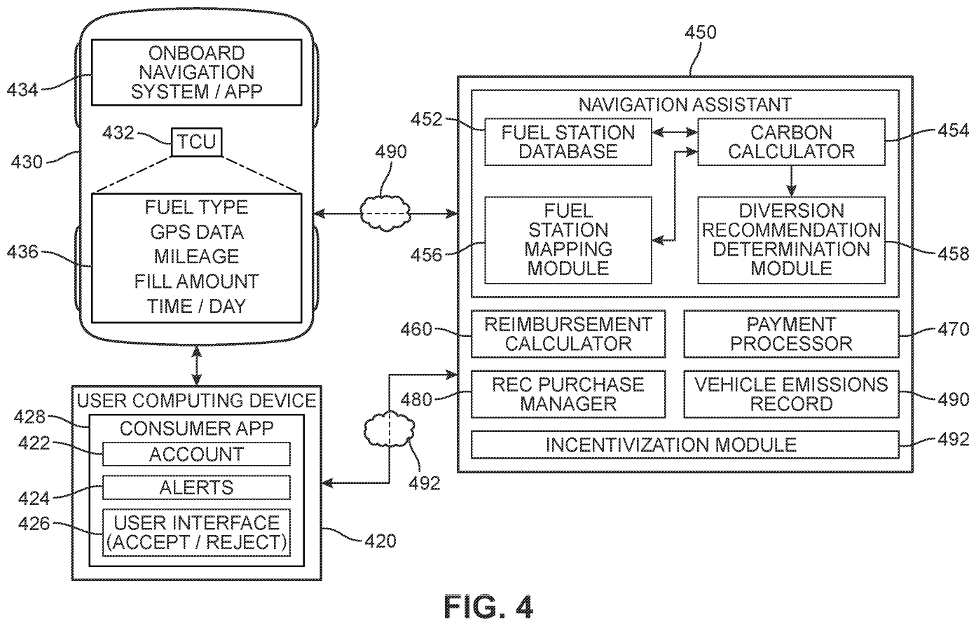

Referring now to FIG. 4, additional details of the system and method are provided by reference to an environment 400 for an embodiment of a clean energy navigation system (“system”) 450. For purposes of this example, the environment 400 includes a vehicle 430 that is configured to transmit data over network 490 to a remote server hosting system 450. As noted earlier, the vehicle 430 can include a telematics control unit (TCU) 432. The TCU 432 comprises a micro-controller that can wirelessly connect the vehicle to cloud services or other vehicles via V2X standards over a mobile network. In addition, the TCU can collect telemetry data 436 from the car. The TCU system connects and communicates with various vehicle sub-systems over data and control busses (e.g., CAN) in the vehicle and collects the associated telemetry data. This data includes elements such as, for example, position, speed, engine data, connectivity quality, etc. The TCU 432 may also provide in-vehicle connectivity through Wi-fi and Bluetooth and enables the e-Call function on relevant markets. Furthermore, for purposes of the proposed systems and methods, the TCU 432 can collect data about the fuel type (e.g., ICE/EV/PHEV/Hydrogen), mileage, fill amount (e.g., gallon gas, kWh, lbs. hydrogen), time, date, mileage and location data when the vehicle is being re-fueled to allow the system to determine the fuel carbon content. It can be appreciated that fuel obtained at a first fueling station on a first date/time may have a first carbon content, and fuel obtained at the same first fueling station on a different second date/time may have a different, second carbon content, so the location and time/date, as well as the estimated time that the vehicle needs to journey from its current location to each fueling station, can be significant when predicting/estimating what the carbon content at each nearby fueling station is most likely to be before the vehicle arrives at that station. In other words, the more accurate the expected or anticipated time/date of arrival of the vehicle at the fueling station, the more accurate the carbon content calculation of that fuel can be.

In addition, in some embodiments, the vehicle 430 can include an onboard navigation system 434. The navigation system 434 can further include a GPS receiver that receives a GPS signal transmitted from a GPS satellite, and a map database that stores map information, in some embodiments, the navigation system 434 measures the location (latitude and longitude) of the vehicle 430 on the basis of the GPS signal received by the GPS receiver. Additionally, in some embodiments, the navigation system 434 presents a guidance route to a set destination on the basis of the measured location of the vehicle 430 and map information acquired from the map database. In some embodiments, the vehicle's navigation system 434 can then calculate a route to a desired location and assist the user in navigating along that route, as well as in identifying points of interest along or near their desired routes. In some cases, to enable navigation services, the vehicle is interconnected with a device, for example, a smartphone or other mobile computing device 420, that includes a navigation application that can be used in the vehicle 430 and serve as the onboard navigation system 434.

In different embodiments, the system 450 can include a navigation assistance module (“navigation assistant”) 440 that communicates with vehicle 430 and manages the identification, recommendation, and diversion mapping/re-routing (transmitting navigation instructions) in coordination with the vehicle's navigation system 434. The navigation assistant 440 can, in some embodiments, receive real-time navigation data from vehicle 430 (e.g., via TCU 432 and navigation system 434) and, when appropriate, identify fueling stations in vicinity of the vehicle's current location or anticipated location based on a target/selected destination. For example, upon detecting via TCU data that the vehicle fuel level has fallen below a preselected threshold (e.g., can be adjusted by the driver), the navigation assistant 440 can trigger the operation of a fuel station mapping module 456 to identify the available fueling stations. In some embodiments, the fuel station mapping module 456 includes GPS or other location data for each fueling station that can be transmitted to the vehicle navigation system and overlaid on the user's map interface and serve as beacons to which the user can choose to be routed. In other embodiments, the navigation system can be supplanted by the system-supplied navigation assistant 440 so that all mapping and routing is provided via the system 450 rather than a local navigation service.

As fueling stations within a preselected range of the vehicle's current location or anticipated location are identified, the navigation assistant 440 can—for each station—perform an assessment of the carbon content of the fuel the station provides. For example, a carbon content calculation module (“carbon calculator”) 454 can, based on location data provided by the fuel station mapping module 456 and fuel characteristics (e.g., including carbon content and cost of fuel) for each station, as provided via a fuel station database 452, calculate an approximate carbon content for each standard unit of fuel in a fueling station. For example, each fueling station will differ in its fuel's carbon content simply based on the station's geographical location (e.g., which state/region/city/township is the station located) and the type of fuel that is offered. Similarly, fuel station database 452 can include data about the station's individual fuel carbon standards (e.g., does the station require its fuel be sourced from a particular renewable energy plant?) that can impact the fuel's overall carbon content.

In addition, in some embodiments, carbon calculator 454 can, with reference to vehicle location data provided by TCU 432 and the navigation system 434, calculate how heavy the carbon emissions will be for each of the driving journeys to the different identified fueling stations. In some embodiments, a diversion recommendation determination module 458 can receive and process the output of these calculations and determine the most optimal fueling station with respect to distance and carbon content, and in some cases, cost, as calculated by the carbon calculator 454. In different embodiments, a ranking of all of the options, or a subset (e.g., “top five” or “top ten” lists) may be generated by the diversion recommendation determination module 458 that identifies the fueling station options in order of most desirable to least desirable in the context of overall carbon emissions (i.e., carbon content of the fuel the station offers and carbon emissions associated with the drive by the vehicle to that station and, if the station is ‘out of the way’ of the driver's final destination, the carbon emissions that are associated with the drive by the vehicle to return to its route to that destination).

In some embodiments, the diversion recommendation determination module 458 can present the options via the onboard navigation system 434, with preference given to the option linked to the least carbon intensity. In another example, the diversion recommendation determination module 458 can transmit instructions over networks 492, 494 to present the options via a user interface 426 of consumer app 428 (accessed on the user computing device 420). For example, a pop-up message, notification, or other alert 424 can be triggered that asks the driver to consider a set of options identified by the system 450. The driver can then select their desired option and, in response, the navigation assistant 440 can cause the navigation system 434 to present guidance (e.g., step by step routing) to the driver from their current location to the selected fueling station. In cases where the driver rejects the proposed options, the navigation assistant 440 can simply disengage and the driver can continue on their own route to their own desired fueling station, without any further interjection. The system can remain disengaged until the driver requests assistance, and/or automatically engage at a future time when the system detects the vehicle has again fallen below the low fuel level threshold and initiates a search for fueling stations near the vehicle's location that would help reduce the vehicle's carbon footprint.

Once the consumer makes a selection from the options showcased by the navigation assistant 440, the system 450 can monitor the telemetry data 436 to verify that the vehicle 430 did indeed travel to the recommended fueling station and how much fuel was added to the vehicle while at that station, and make a final calculation of the carbon that was ‘saved’ or the reduction in carbon emissions that occurred as a result of the driver's choice. This information is shared with a reimbursement calculator 460 that can determine a monetary value to cover the driver's cost in cases where the drive was ‘out of the way’ or indirect with respect to their final destination—for example, to cover the additional fuel that was needed to travel to the selected station and then return to their original route. In addition, the reimbursement amount is based on any increase in cost between the nearby fuel that was available to the driver at a lower price and the higher price of the lower-carbon content fuel that they diverted to. Thus, if the monetary cost of the fuel at the carbon-friendly fuel station is greater than at the driver's preferred fueling station (e.g., the fueling station that would have been their most direct/on the way to their destination option and/or their cheapest option), the reimbursement calculator 460 outputs this difference as an amount that should be reimbursed to the consumer, for example via a payment processor module (“payment processor”) 470. In different embodiments, the payment processor 470 can link to the consumer's bank or other EFT (electronic funds transfer), online payment transfer services, etc. to transfer the amount from the OEM to the driver automatically in response to the reimbursement calculator 460 outputting a value greater than zero. In one embodiment, the appropriate compensation is automatically debited from the OEM account. In some cases, the server is configured to store funds for the OEM that will be used to compensate the owner of the vehicle. In some embodiments, the electronic payments system may use an electronic commerce technology, which may be similar to or incorporate the features of financial services such as but not limited to PayPal®, Venmo®, CashApp®, Google Pay®, Apple Pay®, Square®, etc. In some embodiments, the server may be configured to automatically initiate or perform payment transfers from the OEM or other third-party to a consumer (i.e., vehicle owner) in response to verifying the fuel transaction has occurred.

In some embodiments, a vehicle emissions record 490 can be maintained at the system 450 that updates the vehicle's total carbon emissions based on where fuel is obtained, how much fuel, and type of fuel, as well as mileage and other relevant factors. The record 490 can also include a low-level history of the individual vehicle's emissions across different windows/periods of time (e.g., over a specific time period, average per week, per month, per year, etc.), which the driver can review via an account module 422 for the app 428. This information can also be accessed by an REC purchase manager 480 that can monitor how the driver's choices impact the vehicle's carbon emissions, and how this reduction also decreases the number of RECs that will need to be purchased by the vehicle's OEM. In some embodiments, the REC purchase manager 480 can automatically purchase—when appropriate—the number of RECs to cover/compensate for the vehicle's emissions based on the vehicle emissions record 490. Furthermore, in some embodiments, beyond reimbursements, the system 450 can include an incentivization module 492 that can track the driver's carbon-related decisions in their vehicle (based on vehicle telemetry data and in-app data) and generate (via their app 428) personalized content, media, messages, etc. to encourage the driver toward a particular carbon standard, remind them how their choices have helped the environment, tally their carbon reduction over a given time period and congratulate the driver when they reach a new milestone or record, etc. In some embodiments, the incentivization module 492 can convert the vehicle's saved carbon amount into points or other metric that can be collected and exchanged for a tangible reward (e.g., converted into cash, prizes, vehicle benefits/subscriptions/free maintenance).

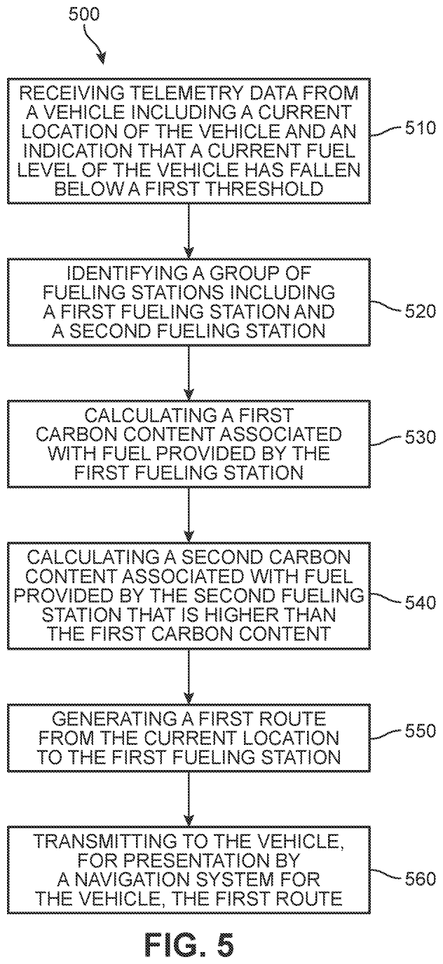

FIG. 5 is a flow chart illustrating an embodiment of a method 500 of for routing vehicles to fueling sources with lower carbon content. At 510, the method may include receiving, at a server, first telemetry data from a vehicle including a current location of the vehicle, and an indication that a current fuel level of the vehicle has fallen below a first threshold. At 520, the method includes identifying, within a first driving range of the vehicle from its current location, a group of fueling stations including a first fueling station and a second fueling station, and at 530 the method includes calculating, based on a first location of the first fueling station, a first carbon content associated with fuel provided by the first fueling station. The method 500 also includes at 540, calculating, based on a second location of the second fueling station, a second carbon content associated with fuel provided by the second fueling station that is higher than the first carbon content. In addition, at 550, the method includes generating, in response to the second carbon content being higher than the first carbon content, a first route from the current location to the first fueling station, and at 560, transmitting to the vehicle's onboard computing/navigation system, for presentation by the navigation system for the vehicle, the first route.

In different embodiments, the method 500 may include additional processes or aspects. In one example, the method also includes defining the first driving range based on the current fuel level of the vehicle and its mileage. In some embodiments, the method also includes estimating a time of day the vehicle would arrive at the first fueling station from its current location; and further calculating the first carbon content based on the time of day the vehicle would arrive at the first fueling station. In another example, the method includes receiving second telemetry data from the vehicle including a first fuel amount obtained by the vehicle at the first fueling station; and updating a carbon emissions record for the vehicle based on the first carbon content and the first fuel amount. In one embodiment, the method also includes presenting, via an application accessed on a mobile computing device associated with a driver of the vehicle, personalized informational messaging about the carbon emissions record. In some embodiments, the method further includes determining a difference in cost per unit of fuel between the first fueling station and the second fueling station; and calculating a reimbursement amount based on the difference in cost per unit of fuel and the first fuel amount. In different embodiments, the method also includes automatically initiating, at the server, on behalf of an original equipment manufacturer of the vehicle, a first payment to an account associated with the vehicle based on the reimbursement amount. In some embodiments, the first telemetry data further includes a type classification for the vehicle, the type classification being one of an internal combustion engine (ICE) vehicle, electric vehicle (EV), plug-in hybrid electric vehicle (PHEV), and hydrogen vehicle

Other methods may be contemplated within the scope of the present disclosure. For example, in some embodiments, a method of routing vehicles to fueling sources with lower carbon content is disclosed. The method includes: receiving, at a server, first telemetry data from a vehicle including a current location of the vehicle, a target destination, and an indication that a current fuel level of the vehicle has fallen below a fuel threshold; identifying, within a first driving range of the vehicle as it travels from its current location to the target destination, a group of fueling stations including a first fueling station and a second fueling station; calculating, based on a first location of the first fueling station, a first carbon content associated with fuel provided by the first fueling station; calculating, based on a second location of the second fueling station, a second carbon content associated with fuel provided by the second fueling station that is higher than the first carbon content; generating, in response to the first carbon content being less than the preselected carbon content threshold, a first route from the current location to the target destination that includes a detour to the first fueling station; and transmitting to the vehicle, for presentation by a navigation system for the vehicle, the first route.

In other embodiments, this method may include additional processes or aspects. In one example, the method also includes estimating a time of day the vehicle would arrive at the first fueling station from its current location; and further calculating the first carbon content based on the time of day the vehicle would arrive at the first fueling station. In another example, the method can include accessing a fuel station database that includes information about a source of the fuel provided by the first fueling station; and further calculating the first carbon content based on the information about the source of the fuel provided by the first fueling station.

Thus, as described herein, the system provides for real-time monitoring of each vehicle's fuel type and carbon intensity, and can reroute the vehicle—even if there are cheaper fueling options available—to a location where the fuel is relatively cleaner. The system can calculate the carbon content of the fuel with reference to the fill-up/charging date, time, and location, in one example, the carbon content calculation results can be overlaid by the system onto the vehicle's onboard navigation map to show the available routing options and fueling locations, and sorting these options by carbon content and fuel price (based on crowd-sourced data similar to apps like the Gas Buddy® application). In cases where the driver has many options to refuel along their recurring commute (e.g., work, home, or certain regularly traveled geolocations), the system can make dynamic recommendations to the user to refuel at specific, clean locations to decrease the vehicle's fuel carbon intensity, even if they must drive a longer distance. The diversion can help minimize the carbon intensity to reduce not only the vehicle's emissions, but the OEM's own scope 3 emissions exposure. In some examples, the OEM may find it to be financially advantageous (i.e., less expensive) to have the vehicle be fueled at a more distant station that offers cleaner fuel because the OEM will then need to purchase fewer RECs. In other words, the system can be automatically triggered to encourage the driver to travel farther to a cleaner fueling station because it will also be cheaper for the OEM to simply reimburse/pay the driver for the excess mileage and/or difference in fuel cost than purchasing REC/PPAs.

As a general matter, an embodiment of the server of FIG. 4 for carbon emissions management and navigation is described below, explained in conjunction with other elements from FIG. 4. As a general matter, the server may include circuitry, a memory, an I/O device, and a network interface. The circuitry may be coupled to the memory, the I/O device, and the network interface, through wired or wireless connections of the communication networks.

The circuitry may include any suitable special-purpose or general-purpose computer, computing entity, or processing device including various computer hardware or software modules and may be configured to execute instructions stored on any applicable computer-readable storage media (for example the memory). The circuitry may be implemented based on a number of processor technologies known in the art. For example, the circuitry may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. The circuitry may include any number of processors configured to, individually or collectively, perform any number of operations of the server, as described in the present disclosure. Examples of the circuitry may include a Central Processing Unit (CPU), a Graphical Processing Unit (GPU), an x86-based processor, an x64-based processor, a Reduced Instruction Set Computing (RISC) processor, a Complex Instruction Set Computing (CISC) processor, and/or other hardware processors.

The memory may include suitable logic, circuitry, interfaces, and/or code that may be configured to store the set of instructions executable by the circuitry. The memory may be configured to store the registration information for the transfer devices. The memory may be further configured to store the electric charging information, the renewable credit information, and the monetary information. Examples of implementation of the memory may include, but are not limited to, Random Access Memory (RAM), Read Only Memory (ROM), Hard Disk Drive (HDD), a Solid-State Drive (SSD), a CPU cache, and/or a Secure Digital (SD) card.

The I/O device may include suitable logic, circuitry, interfaces, and/or code that may be configured to receive user inputs and generate outputs in response to the received user inputs. The I/O device may receive the registration information associated with a new electric charging facility device as the user-input. For example, the server may receive the user-input from an executive of the organization associated with or handling the server for the REC management. The I/O device may include various input and output devices, may be configured to communicate with the circuitry. Examples of the I/O device may include, but are not limited to, a touch screen, a keyboard, a mouse, a joystick, a microphone, a display device, a speaker, and/or an image sensor.

The network interface may include suitable logic, circuitry, and interfaces that may be configured to facilitate communication between the circuitry, the fueling facility devices, the electronic device of the OEMs, the electric grid device of an electric grid, the communication device of the renewable energy generation sources, and the electronic apparatus of the vehicle, via the communication network. The network interface may be implemented by use of various known technologies to support wired or wireless communication of the server with the communication network. The network interface may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging and a Short Message Service (SMS).

While the server in this case includes the circuitry, the memory, the I/O device, and the network interface, the disclosure should not be construed as limiting the server and may include more or less components to perform the same or other functions of the server. Details of the other functions and the components have been omitted from the disclosure for the sake of brevity. The functions or operations executed by the server may be performed by the circuitry. It should be understood that the server may be combined with the transfer devices to form a system. The transfer devices may be communicably coupled with the network Interface, via a communication network.

The following includes definitions of selected terms employed herein. The definitions include various examples and/or forms of components that fall within the scope of a term and that may be used for implementation. The examples are not intended to be limiting. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system includes one or more processors. A “processor”, as used herein, generally processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

The apparatus and methods described herein and illustrated in the accompanying drawings by various blocks, modules, components, circuits, steps, processes, algorithms, etc. (collectively referred to as “elements”) may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

The processor may be connected to a communication infrastructure (e.g., a communications bus, cross-over bar, or network). Various software aspects are described in terms of this example computer system. After reading this description, it will become apparent to a person skilled in the relevant art(s) how to implement aspects described herein using other computer systems and/or architectures.

Computer system may include a display interface that forwards graphics, text, and other data from the communication infrastructure (or from a frame buffer) for display on a display unit. Display unit may include display, in one example. Computer system also includes a main memory, e.g., random access memory (RAM), and may also include a secondary memory. The secondary memory may include, e.g., a hard disk drive and/or a removable storage drive, representing a floppy disk drive, a magnetic tape drive, an optical disk drive, etc. The removable storage drive reads from and/or writes to a removable storage module in a well-known manner. Removable storage module, represents a floppy disk, magnetic tape, optical disk, etc., which is read by and written to removable storage drive. As will be appreciated, the removable storage module includes a computer usable storage medium having stored therein computer software and/or data.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals, which may be electronic, electromagnetic, optical or other signals capable of being received by communications interface. These signals are provided to communications interface via a communications path (e.g., channel). This path carries signals and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals. These computer program products provide software to the computer system. Aspects described herein may be directed to such computer program products. Communications device may include communications interface.

Computer programs (also referred to as computer control logic) are stored in main memory and/or secondary memory. Computer programs may also be received via communications interface. Such computer programs, when executed, enable the computer system to perform various features in accordance with aspects described herein. In particular, the computer programs, when executed, enable the processor to perform such features. Accordingly, such computer programs represent controllers of the computer system.

In variations where aspects described herein are implemented using software, the software may be stored in a computer program product and loaded into computer system using removable storage drive, hard disk drive, or communications interface. The control logic (software), when executed by the processor, causes the processor to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s). In yet another example variation, aspects described herein are implemented using a combination of both hardware and software.

The foregoing disclosure of the preferred embodiments has been presented for purposes of illustration and description. It is not intended to be exhaustive or to limit the embodiments to the precise forms disclosed. Many variations and modifications of the embodiments described herein will be apparent to one of ordinary skill in the art in light of the above disclosure.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps or processes. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art may readily appreciate that the sequences may be varied and still remain within the spirit and scope of the present embodiments.

1. A method for routing vehicles to fueling sources with lower carbon content, the method comprising:
receiving, at a server, first telemetry data from a vehicle including a current location of the vehicle, and an indication that a current fuel level of the vehicle has fallen below a first threshold;
identifying, within a first driving range of the vehicle from its current location, a group of fueling stations including a first fueling station and a second fueling station;
calculating, based on a first location of the first fueling station, a first carbon content associated with fuel provided by the first fueling station;
calculating, based on a second location of the second fueling station, a second carbon content associated with fuel provided by the second fueling station that is higher than the first carbon content;
generating, in response to the second carbon content being higher than the first carbon content, a first route from the current location to the first fueling station; and
transmitting to the vehicle, for presentation by a navigation system for the vehicle, the first route.

2. The method of claim 1, further comprising defining the first driving range based on the current fuel level of the vehicle and its mileage.

3. The method of claim 1, further comprising:
estimating a time of day the vehicle would arrive at the first fueling station from its current location; and
further calculating the first carbon content based on the time of day the vehicle would arrive at the first fueling station.

4. The method of claim 1, further comprising:
receiving second telemetry data from the vehicle including a first fuel amount obtained by the vehicle at the first fueling station; and
updating a carbon emissions record for the vehicle based on the first carbon content and the first fuel amount.

5. The method of claim 4, further comprising presenting, via an application accessed on a mobile computing device associated with a driver of the vehicle, personalized informational messaging about the carbon emissions record.

6. The method of claim 4, further comprising:
determining a difference in cost per unit of fuel between the first fueling station and the second fueling station; and
calculating a reimbursement amount based on the difference in cost per unit of fuel and the first fuel amount.

7. The method of claim 6, further comprising automatically initiating, at the server, on behalf of an original equipment manufacturer of the vehicle, a first payment to an account associated with the vehicle based on the reimbursement amount.

8. The method of claim 1, wherein the first telemetry data further includes a type classification for the vehicle, the type classification being one of an internal combustion engine (ICE) vehicle, electric vehicle (EV), plug-in hybrid electric vehicle (PHEV), and hydrogen vehicle.

9. A method for routing vehicles to fueling sources with lower carbon content, the method comprising:
receiving, at a server, first telemetry data from a vehicle including a current location of the vehicle, a target destination, and an indication that a current fuel level of the vehicle has fallen below a fuel threshold;
identifying, within a first driving range of the vehicle as it travels from its current location to the target destination, a group of fueling stations including a first fueling station and a second fueling station;
calculating, based on a first location of the first fueling station, a first carbon content associated with fuel provided by the first fueling station;
calculating, based on a second location of the second fueling station, a second carbon content associated with fuel provided by the second fueling station that is higher than the first carbon content;
generating, in response to the first carbon content being less than the preselected carbon content threshold, a first route from the current location to the target destination that includes a detour to the first fueling station; and
transmitting to the vehicle, for presentation by a navigation system for the vehicle, the first route.

10. The method of claim 9, further comprising:
estimating a time of day the vehicle would arrive at the first fueling station from its current location; and
further calculating the first carbon content based on the time of day the vehicle would arrive at the first fueling station.

11. The method of claim 9, further comprising:
accessing a fuel station database that includes information about a source of the fuel provided by the first fueling station; and
further calculating the first carbon content based on the information about the source of the fuel provided by the first fueling station.

12. A system for routing vehicles to fueling sources with lower carbon content, the system comprising a processor and machine-readable media including instructions which, when executed by the processor, cause the processor to:
receive, at a server, first telemetry data from a vehicle including a current location of the vehicle, and an indication that a current fuel level of the vehicle has fallen below a first threshold;
identify, within a first driving range of the vehicle from its current location, a group of fueling stations including a first fueling station and a second fueling station;
calculate, based on a first location of the first fueling station, a first carbon content associated with fuel provided by the first fueling station;
calculate, based on a second location of the second fueling station, a second carbon content associated with fuel provided by the second fueling station that is higher than the first carbon content;
generate, in response to the second carbon content being higher than the first carbon content, a first route from the current location to the first fueling station; and
transmit to the vehicle, for presentation by a navigation system for the vehicle, the first route.

13. The system of claim 12, wherein the instructions further cause the processor to define the first driving range based on the current fuel level of the vehicle and its mileage.

14. The system of claim 12, wherein the instructions further cause the processor to:
estimate a time of day the vehicle would arrive at the first fueling station from its current location; and
further calculate the first carbon content based on the time of day the vehicle would arrive at the first fueling station.

15. The system of claim 12, wherein the instructions further cause the processor to:
receive second telemetry data from the vehicle including a first fuel amount obtained by the vehicle at the first fueling station; and
update a carbon emissions record for the vehicle based on the first carbon content and the first fuel amount.

16. The system of claim 15, wherein the instructions further cause the processor to present, via an application accessed on a mobile computing device associated with a driver of the vehicle, personalized informational messaging about the carbon emissions record.

17. The system of claim 15, wherein the instructions further cause the processor to:
determine a difference in cost per unit of fuel between the first fueling station and the second fueling station; and
calculate a reimbursement amount based on the difference in cost per unit of fuel and the first fuel amount.

18. The system of claim 17, wherein the instructions further cause the processor to automatically initiate, at the server, on behalf of an original equipment manufacturer of the vehicle, a first payment to an account associated with the vehicle based on the reimbursement amount.

19. The system of claim 12, wherein the first telemetry data further includes a type classification for the vehicle, the type classification being one of an internal combustion engine (ICE) vehicle, electric vehicle (EV), plug-in hybrid electric vehicle (PHEV), and hydrogen vehicle.

20. The system of claim 12, wherein the instructions further cause the processor to:
access a fuel station database that includes information about a source of the fuel provided by the first fueling station; and
further calculate the first carbon content based on the information about the source of the fuel provided by the first fueling station.
